(19) United States
(12) Patent Application Publication
(10) Pub. No.: US 2008/0196559 A1
(43) Pub. Date: Aug. 21, 2008

(54) MULTI PURPOSE DRIVING TOOL

(75) Inventor: Scott W. ALLAN, Waterloo (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: TEAM FAIR HOLDINGS LIMITED, Road Town (VG)

(21) Appl. No.: 12/034,278

(22) Filed: Feb. 20, 2008

Related U.S. Application Data
(60) Provisional application No. 60/890,642, filed on Feb. 20, 2007.

(51) Int. Cl. B25B 23/16; B25G 1/08

(52) U.S. Cl. 81/177.85; 81/490

(57) ABSTRACT

There is provided multi-purpose driving tool comprising a first end having a fastener driving housing apparatus for receiving a fastener driving apparatus; a second end having a tool housing apparatus for receiving a functioning driving apparatus or functioning accessory; and a pivot point, located between the first and second ends; wherein the first end and the second end can be pivoted with respect to each other.

### CROSS REFERENCE TO RELATED APPLICATION

This application claims the benefit of priority of U.S. Provisional Patent Application No. 60/890,642 filed Feb. 20, 2007, which is incorporated herein by reference in its entirety.

### FIELD OF THE INVENTION

This invention, in general relates to the field of driving tools, and in particular to a multi purpose driving tool.

### BACKGROUND OF THE INVENTION

Generally drivers, or driving tools, comprise a handle made up of synthetic materials like plastic firmly attached to a metal rod that have an end suitable to cooperate with a fastener or used in a fastener application. However, such drivers typically hold a bit suitable for one application only. If a user were to further require to prepare a hole for a fastener, another tool would be needed as well. Thereby separate screwdrivers and implements are required for different driving applications. Further it is difficult to use these screwdrivers in places where there are space limitations are as they have firm handles that cannot be adjusted as per the space and leverage requirements.

There are also multi-drivers that include multiple bits that can be inserted into one end of the driver for exchangeability from one type of drive bit to another type of drive bit. These however are typically for one standard size bit, that being a ¼″ hex shank bit. These items are bulky to use and offer limited functionality in the typical uses of a driver.

### SUMMARY OF THE INVENTION

It is an aspect of the present invention to provide a multipurpose driving tool having functional capabilities at both ends for assisting with the driving application thereby enabling the driver to operate from either end depending upon the functional requirement.

Another aspect of the present invention is to provide a multipurpose driving tool having an angular displacement to the driver handle depending upon the need in order to have simplicity in driving application or assistance at either end and provides versatility and torque advantage for specific need, shape, form and simplicity in driving applications.

It is another aspect of the invention, wherein the length of said driver can vary in accordance to the leverage to be best suited for driving application or implement at either end.

It is yet another aspect of the invention to provide a multipurpose driving tool comprising locking means for the driving tool such that the angular orientation may be locked.

It is yet another aspect of the invention that one of the locking means may provide functional grip at the desired position for driving operation in straight drive position and comfortable grip in angular position.

A further aspect of the present invention is to provide driving capability for a standard ¼″ hex driving bit be held in one end and a precision 5/32″ hex bit at the other end.

Yet a further aspect of the present invention is to provide chucks at either one end or at both the ends of said multipurpose driving tool for holding standard and precision bits.

It is yet another aspect of the invention to provide multipurpose driving tool optionally comprises a magnetic base to the bit holders for securing standard and precision bits magnetically.

It is yet another aspect of the invention to provide a multipurpose driving tool that comprises capability for driving bit to be held at one end and a driving application assisting device at the other end.

Further in accordance with another aspect of the present invention, wherein said multipurpose driving tool optionally comprises space for storing bits in the shank of the driver and a cap and/or clip for convenient storage into a pocket or other convenient storage.

Another aspect of the invention is to provide a multipurpose driving tool having a handle which provides adequate support to a user for driving applications.

In another aspect of the invention, there is provided a multi-purpose driving tool comprising a first end having a fastener driving housing apparatus for receiving a fastener driving apparatus; a second end having a tool housing apparatus for receiving a functioning driving apparatus or functioning accessory; and a pivot point, located between the first and second ends; wherein the first end and the second end can be pivoted with respect to each other.

In yet a further aspect, there is provided a multi-purpose driving tool comprising a first end having a fastener driving housing apparatus for receiving a fastener driving apparatus; a second end having an integrated functioning driving apparatus or functioning accessory; and a pivot point, located between the first and second ends; wherein the first end and the second end can be pivoted with respect to each other.

### BRIEF DESCRIPTION OF THE DRAWINGS

Embodiments of the present application will now be described, by way of example only, with reference to the attached Figures, wherein:

FIGS. 1a to 1e are schematic views of a first embodiment of a multi-purpose driving tool;

FIGS. 2a to 2g are various views of a second embodiment of a multi-purpose driving tool; is a cross-sectional view of a second embodiment of a multi-purpose driving tool;

FIG. 3 is a perspective view of another embodiment of a driving tool;

FIGS. 4a and 4b are perspective views of a further embodiment of a driving tool;

FIGS. 5a to 5c are perspective views of further embodiments of a multi-purpose driving tool;

FIG. 6a is a perspective view of yet another embodiment of a multi-purpose driving tool;

FIG. 6b is a schematic view of the driving tool in FIG. 6a clipped to an individual's pocket;

FIG. 7 is a schematic view showing various angular positions of the driving tool;

FIGS. 8a and 8b are cross sectional views of a push-button pivot point;

FIG. 9 is a cross-sectional view of another embodiment of a pivot point;

FIGS. 10a and 10b are views of other embodiments of a driving tool;

FIG. 11 is a perspective of a further embodiment of a multi-purpose driving tool;

FIG. 12 is a perspective of another embodiment of a multi-purpose driving tool; and

FIG. 13 is a perspective of yet another embodiment of a multi-purpose driving tool.

### DETAILED DESCRIPTION

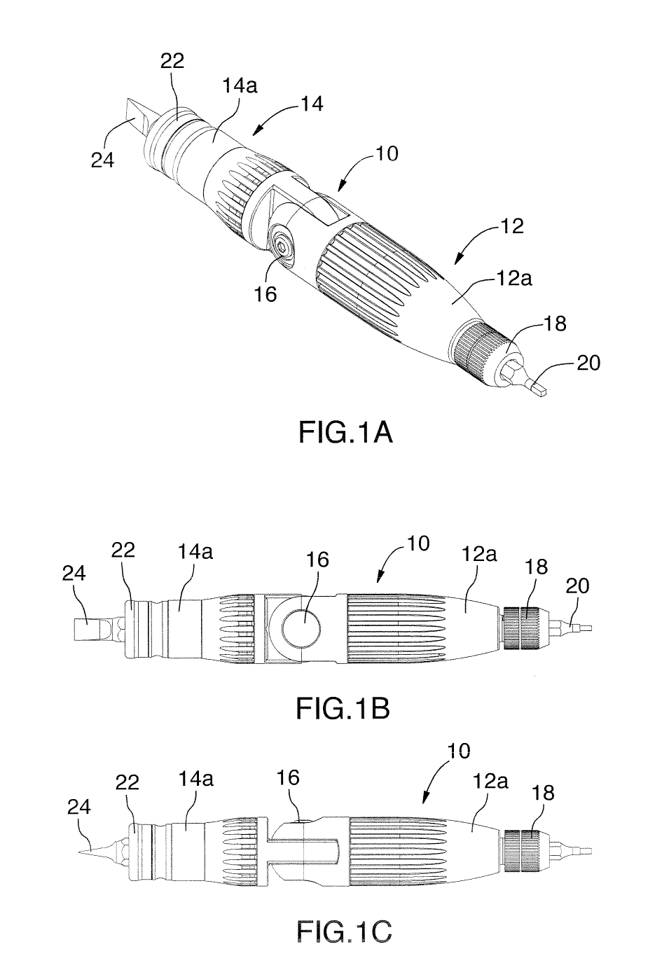

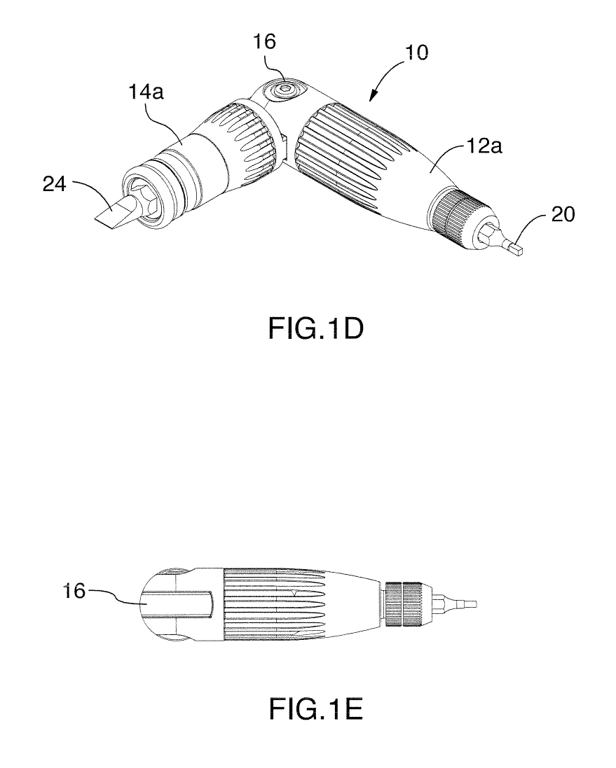

Turning to FIGS. 1a to 1e, several views of a first embodiment of a multipurpose driving tool 10 are provided. The driving tool 10 includes a first end 12, seen as shank portion 12a, a second end 14, seen as shank portion 14a, and a pivot point 16, located between the first 12 and second 14 ends so that the first end 12 and the second end 14 can be pivoted with respect to each other. When one of the ends 12 and 14 is pivoted with respect to the other end, a handle is provided by one end to the other end and vice versa, as shown in FIG. 1d. Both shank portions 12a and 14a are preferably cylindrical thereby providing a somewhat cylindrical driving tool 10.

The first end 12 includes a fastener driving housing 18, seen as a bit housing apparatus, for housing a fastener driving apparatus 20, such as a standard bit, a precision bit, a nut setter, a precision extension or a precision flex shaft. The second end 14 includes a second end housing apparatus 22, seen as a functioning accessory housing apparatus or tool housing apparatus, for receiving a functioning driving apparatus, such as a tool bit 24 or tool accessory. Examples of a tool accessory include, but are not limited to, a magnifying glass, a light, a pencil, a pen, a saw blade, a knife blade, a telescoping magnetic and an adjustable wrench. In the current embodiment, the tool housing apparatus 22 and the bit housing apparatus 18 are chuck/collet apparatus although other known methods and apparatus for receiving and housing bits, tool bits and/or tool accessories are contemplated.

As shown in FIG. 1d, when the first end 12 and the second end 14 are pivoted with respect to each other, the first end shank portion 12a provides a handle to the functioning tool bit 24 or tool accessory housed in the tool housing apparatus 22 and the second end shank portion 14a provides a handle for using the fastener driving apparatus 20 that is housed in the bit housing apparatus 18. As will be understood, although the first 12 and second 14 ends are shown perpendicular to each other, the first 12 and second 14 ends can be located at any angle between 180 degrees to 90 degrees with respect to each other. In a preferred embodiment, the pivot point 16 can be locked in a preferred position so that the ends do not pivot during use of the tool 10. The length of each shank portion 12a and 14a is preferably determined by structure of the bit housing apparatus 18 and the tool housing apparatus 22, respectively.

In the position, shown in FIG. 1a, the tool can be used as a typical driver and represents a standard form of a known screwdriver while in FIG. 1d, the tool 10 can be pivoted in order to provide additional assistance in driving a screw.

In a preferred embodiment, the pivot point 16 includes structural elements which are manufactured from steel thereby providing added strength to the pivot joint during use of the tool 10.

As will be understood, during use, either the functional tool bit 24 of the precision bit 20 can be removed from its respective housing and the tool used as a standard screwdriver or precision bit driver.

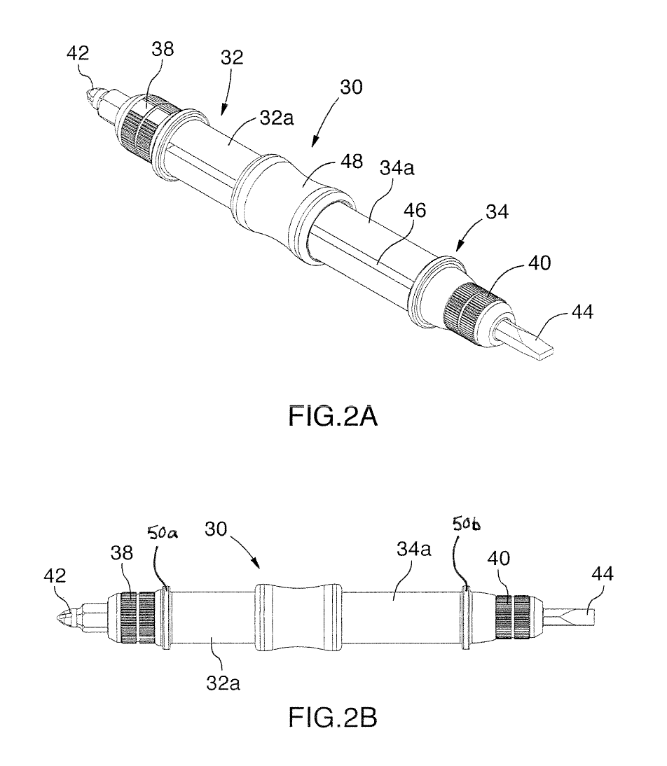

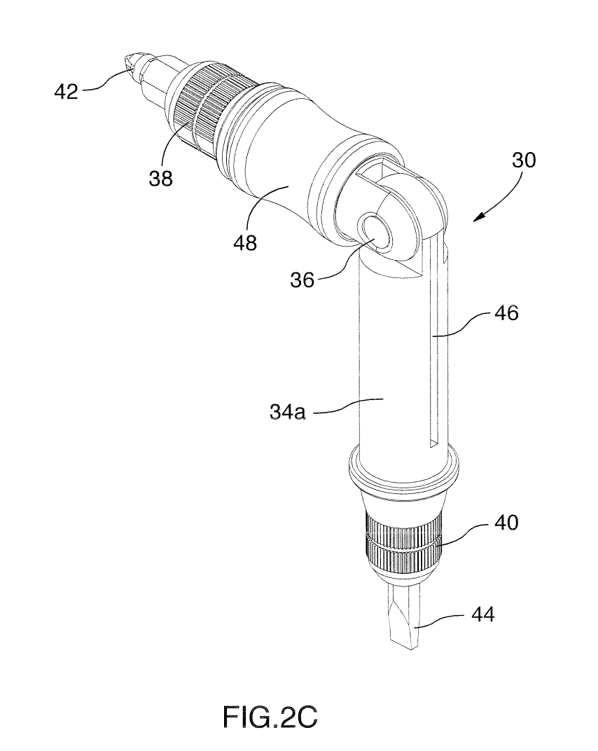

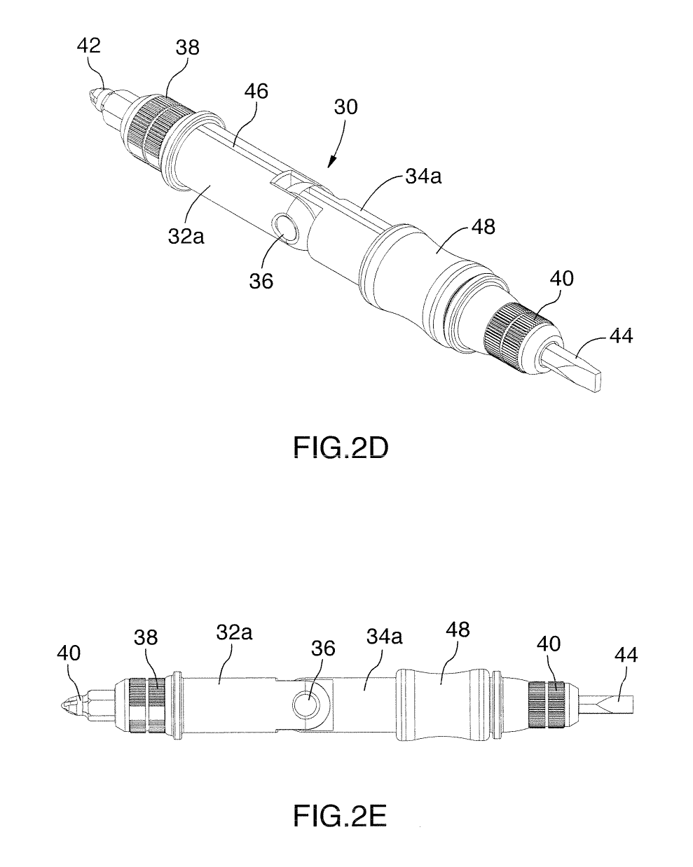

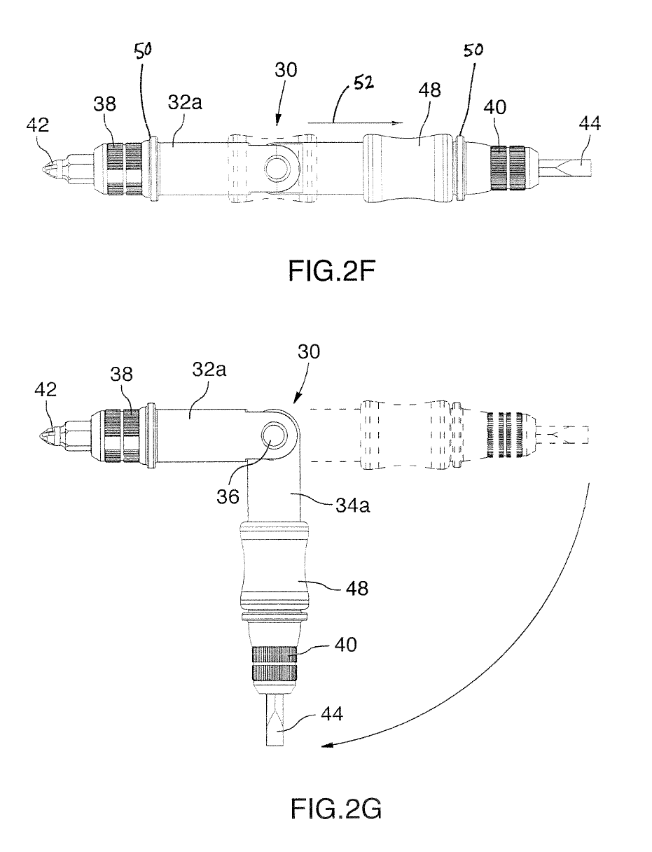

Turning to FIGS. 2a to 2g, schematic views of another embodiment of a driving tool is shown. The tool 30 includes a first end 34, comprising a first end shank portion 34a, and a second end 32, comprising a second end shank portion 32a, connected together by a pivot point 36 (as shown in FIGS. 2c and 2d). In the current embodiment, the first end 34 includes a precision bit housing apparatus 40 for receiving and holding precision, or standard, bits 44 and the second end 32 includes a tool housing apparatus, or means, 38 for receiving and housing, or holding, standard bits 42 or tool driving tool accessories. Typically, the precision bit housing apparatus 40 is narrower than the standard bit housing apparatus 38. In the current embodiment, both the bit retaining apparatus 40 and the tool housing apparatus 38 are chuck assemblies which include tightening means to facilitate the receipt of the tool bit or accessory and to transfer torque effectively. In another embodiment, a quick connect chuck can be used.

In the current embodiment, the tool 30 further includes a hand grip collar 48 which is engaged with a groove 46 (located along a length of the tool 30) comprising a first end groove portion and a second end groove portion located on the first end 34 and second end 32, respectively. Flange portions 50b and 50a are located near the precision bit housing apparatus 40 and the standard bit housing apparatus 38 to prevent the movement of the hand grip collar 48 past the respective ends of the tool 30 so that the collar 48 can not be accidentally removed.

In FIGS. 2a and 2b, the driving tool 30 is in a straight position with the hand grip collar 48 positioned over the pivot point 36 thereby securing the first end shank portion 34a and the second end shank portion 32a from rotating with respect to each other and causing the tool 30 to remain in the straight position. In an alterative embodiment, additional friction means within the pivot point or other locking means can be employed to maintain positional relativity.

As with the description of the previous embodiment, the tool 30 can be kept straight for typical driver use as it represents the form of most standard screwdrivers or the ends 32 and 34 can be adjusted angularly with respect to each other to enable alternative positions of use, such as in FIG. 2c.

Accordingly the hand grip collar 48 can be urged along the grooves to provide a grip to the user during use of the tool 30 (FIGS. 2c to 2e). This is beneficial when there is extra torque that is required in order to protect the user's hand from injury and provide an improved grip to the tool 30. The grooves 46 also serve to prevent any rotational displacement of the collar 48 when the tool is being rotated during use. As shown in FIGS. 2c to 2e, the collar 48 has been slid over one of the ends 32 or 34 for a driving application. Typically, the grip is placed in a position where it is comfortable for the user. In some cases, such as in FIG. 2c, the user can place the collar 48 over the second end 32 in order to use the bit 44 or the bit 42 depending on the driving application.

As shown in FIGS. 2f and 2g, in order to use the driving tool 30 in a non-straight position, the hand grip collar 48 is urged away, such as in the direction of arrow 52, from the pivot point 36 to allow for angular displacement of the first end 34 and the second end 32 with respect to each other. The two ends 32 and 34 can then be rotated between 180 degrees (the straight position of FIG. 2f) and 90 degrees (the perpendicular position of FIG. 2g) thereby allowing one of the shanks 32a or 34a to act as a handle for the other shank for improved grip and leverage. As the collar 48 is located on the first end 34, it is likely that the user wishes to use the precision bit 42 in a driving application, however, as disclosed above, the user can also use the bit 44 when the gripping collar 48 is on the first end 34. In another embodiment, the two ends can be positioned at any angle between 90 and 180 degrees with respect to each other, such as 135 degrees. As will be understood, the collar 48 can also be moved onto the second end to allow for pivoting to occur, as shown in FIG. 2c.

The hand grip collar 48 is preferably moved to a desired position on the shank portion acting as the handle to provide a firm grip for the tool 30. The grip collar 48 can be adjusted to provide a functional grip as well as a comfort grip at any desired driving position. Although FIGS. 2a to 2g show a sliding hand grip collar, it will be understood that alternate locking and gripping means are contemplated.

In operation, in one embodiment, if the first end 34 is being used, the multipurpose driving tool 30 is a precision bit driver when a precision bit is placed in the bit retaining apparatus 40 while the second end 32 serves as a handle for the driving tool 30. If the second end 32 is being used in the driving application, the multi-purpose drive tool 30 is a standard bit driver when a standard bit is placed in the tool housing apparatus 40 and the first end 34, with the collar grip 48, acts as a handle for the driving tool 30.

In this embodiment (FIGS. 2a to 2g), the location of the pivot point is located such that the second end shank portion 32a is shorter in length than first end shank portion 34a thereby providing less leverage when the tool is used as a precision bit driver than when it is used as a standard bit driver. This is to provide relativity of torque leverage to the application since precision fasteners require less torque strength than a standard fastener, resulting in fewer over-torque situations, or scenarios.

In an alternative embodiment, the bit retaining apparatus 40 is a precision bit holder that can be hexagonally shaped to receive a standard 5/32 inch hexagonal driver, however it can be dimensioned to receive other sized bits and accessories depending upon the application. Similarly, the tool housing apparatus 40 can be a standard bit holder which is hexagonally shaped and adapted to receive hexagonally shaped tool bits having standard dimensions of approximately ¼ inch measured from face to face, or shaped and sized to receive other tool bits or accessories.

In a further embodiment, the driving tool can include positional detents or locking devices so as to enable the pivot point to be locked in previously determined positions.

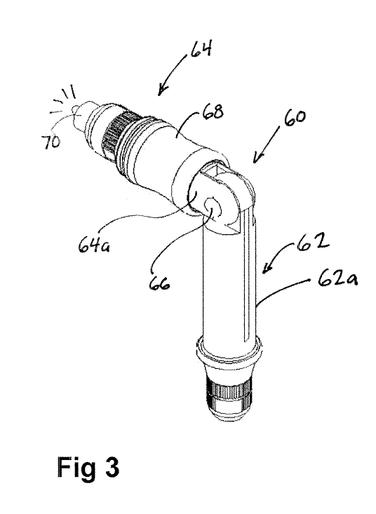

Turning to FIG. 3, yet a further embodiment of a driving tool is shown. The driving tool 60 includes a first end 62, seen as first end shank portion 62a, a second end 64, seen as second end shank portion 64a and a pivot point 66 whereby the first end 62 and the second end 64 can be pivoted with respect to each other. The tool 60 also includes a gripping collar 68. The tool 60 includes a light emitting device 70 which is integrated with the second end 64 to provide an illumination source. Similarly the multipurpose driving tool 60 can include other integrated driving assisting devices as well. The advantages as previously described such as angular positioning for improved functionality or leverage further can also benefit the driving assisting devices.

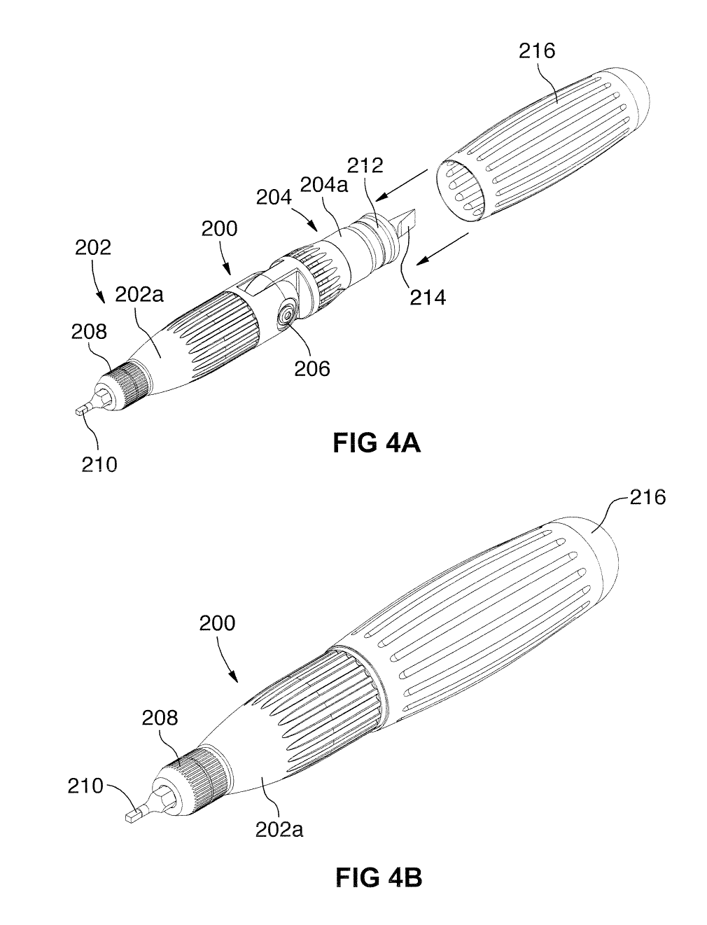

Turning to FIGS. 4a and 4b, a further embodiment of a driving tool is provided. FIG. 4a shows a tool 200 having a first end 202 and a second end 204. The first end 202 including a shank portion 202a and the second end 204 including a shank portion 204a. A pivot point 206 is located between the two ends to allow the first end 202 and the second end 204 to pivot with respect to each other. The tool further includes a cap 216 which can protect one end when the other end is being used. The cap 216 further serves as a handle to the driving tool 200 and can also be used as a lock to the pivot point 206 to prevent the first end 202 and second end 204 from accidentally pivoting when the tool 200 is in use. This is more clearly shown in FIG. 4b where the cap 216 is placed over the second end 204. When the cap is used as a handle, the handle adequately assists in the driving of the bit.

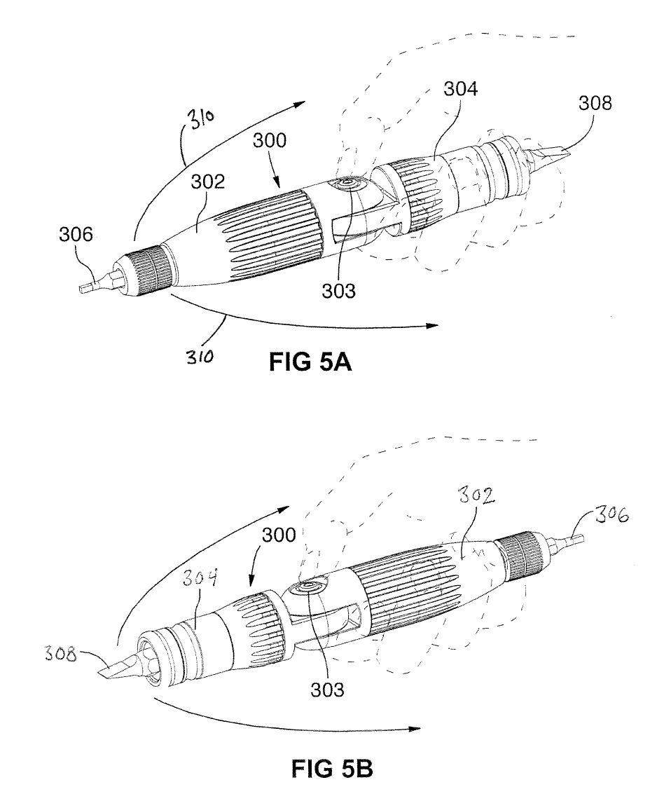

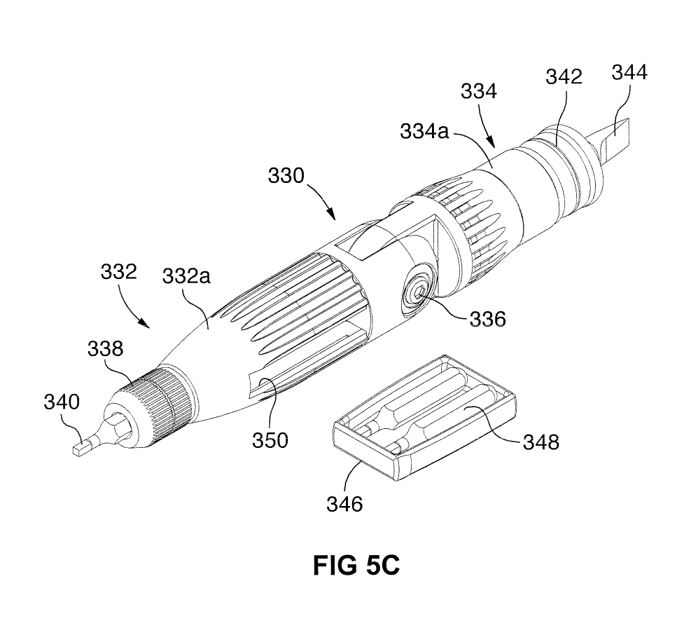

Turning to FIGS. 5a and 5b, yet another embodiment of a multi purpose driving tool is shown. The driving tool 300 includes a first end 302, including a first end shank portion 302a, a second end 304, including a second end shank portion 304a, and a pivot point 303, located between the first and second ends thereby allowing the first end 302 and the second end 304 to be pivoted with respect to each other. In this embodiment, the first end receives a precision bit 306 while the second end 308 receives a standard bit 308, however as discussed above, other bits or tool accessories are contemplated.

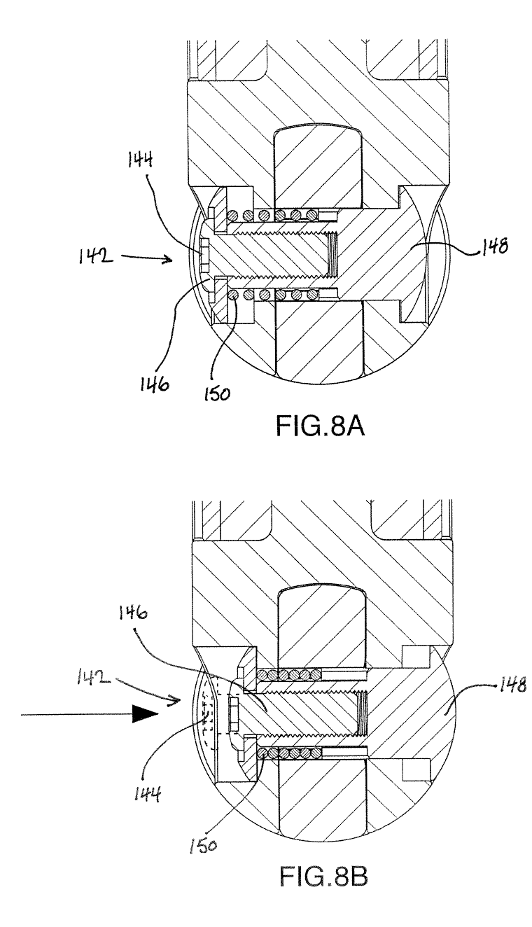

In this embodiment, the pivot point 303 is a push-button pivot point such that the pivot point 303 is locked and the ends 302 and 304 can not pivot with respect to each other until a user releases the pivot point 303, by pressing a push button release mechanism. An example of an embodiment of a push-button release mechanism is shown in FIGS. 8a and 8b, which will be described below.

Therefore, after the user pushes the push button mechanism to release the pivot point, the first end 302 can pivot in either direction (as shown by arrows 310) thereby providing 180 degrees of rotation. In FIG. 5a, the first end 302 is being pivoted and in FIG. 5b, the second end 304 is being pivoted.

Turning to FIG. 5c, yet a further embodiment of a tool is shown. In the embodiment of FIG. 5c, the tool 330 includes a first end 332, comprising a first end shank portion 332a, a second end 334, comprising a second end shank portion 334a, and a pivot point 336 about which the first end and the second end can pivot with respect to each other. A fastener driving apparatus housing 338 is located on the first end 332 to receive a precision bit 340 and a tool accessory apparatus housing 342 is located on the second end 334 to receive a standard bit 344. A slot 350 within the first end 332 receives a storage box 346 which houses further bits 348 and of tool accessories, which can be inserted into either the fastener driving apparatus housing 338 or the tool accessory apparatus housing 342.

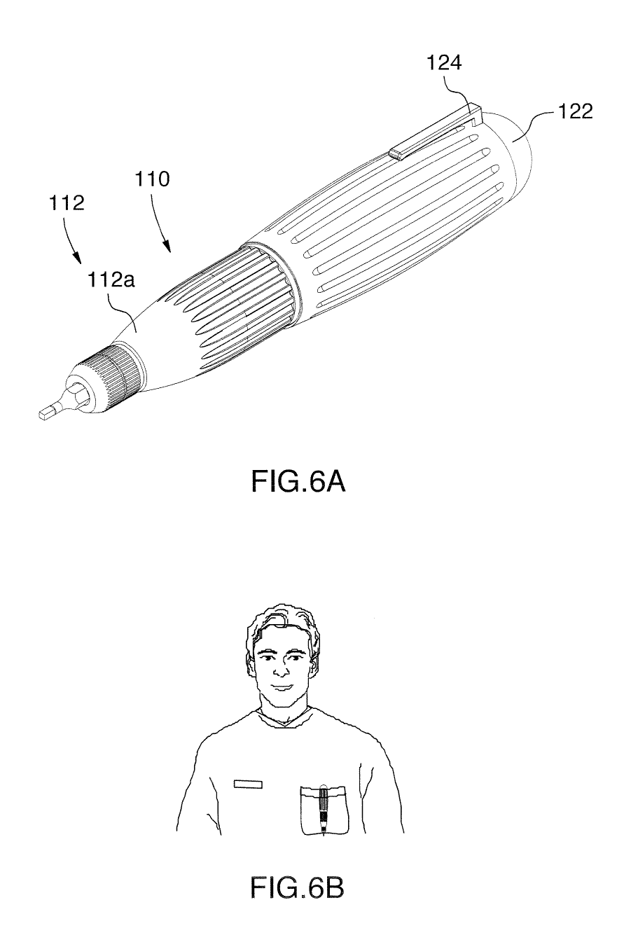

Turning to FIG. 6, yet a further embodiment of a driving tool is shown. The drive tool 110 includes a first end 112 comprising a first end shank portion 112a and a second end which is covered by a cap 122. As with the previous embodiments, the second end includes a second end shank portion and a tool accessory apparatus housing. The cap 122 protects the tool from being damaged and can be used as a handle for the tool and as a locking mechanism for the pivot point (as in the embodiment of FIG. 4a and 4b). A clip 124 allows the tool 110 to be clipped to a user's, or individual's pocket so the tool is easily portable (FIG. 6b).

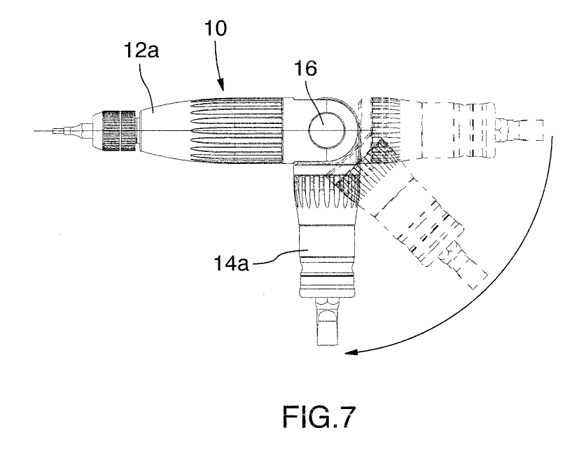

Turning to FIG. 7, a schematic diagram the tool in multiple angular positions is shown. As discussed above with respect to FIG. 1, the driving tool 10 includes the first end 12 and the second end 14. The pivot point 16 is located between the first end 12 and the second end 14 to allow the two shank portions 12a and 14a to be pivoted with respect to each other. As seen in FIG. 7, the ends of the tool 10 are shown perpendicular to each other. However, if preferred, the second end 14 of the tool 10 can be pivoted, or rotated, to other positions, as outlined by the dotted lines of FIG. 7. In the preferred embodiment, the ends can be placed in three separate angular positions (as shown) with respect to each other, however, other angles are possible, depending on the type of pivot point 16 being used.

FIGS. 8a and 8b provide an enlarged cross-sectional view of an embodiment of the push button lock/pivot point. The push button lock 142 includes a button 144 that includes a plunger portion 146 which is attached, connected to, or located within a complimentary mating portion 148 which includes a spline portion. A spring 150 is located around the mating portion 148.

In FIG. 8a, the spring 150 is in an elongated position and the pivot point is locked, or prevented, from pivoting. As will be understood, the two ends of the tool are mated together, via a gear or the spline portion, and are held in place by the spring, or locking mechanism. In the current embodiment, a tongue and clevis system is used for the mating of the two ends.

When a user presses the button 144, the spring 150 is compressed and causes the plunger portion 146 to move inward (as shown by the arrow) causing the mating portion 148 to move as well. The movement of the mating portion 148 releases the connection between two ends and allows the two ends to pivot with respect to each other about the spline to a desired location before the button 144 is released causing the spring 150 to decompress and return to the elongated position thereby locking the first end and the second end back together.

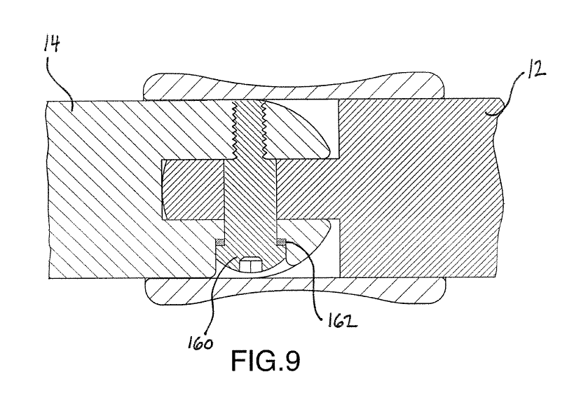

Turning to FIG. 9, a further embodiment of a pivot point is shown. In this embodiment, the pivot point is seen as a friction pivot point. The pivot point includes a screw 160 which includes a washer 162, located directly underneath the head of the screw 160. When the pivot point is created for the tool, the screw 160 is inserted through the two ends 12 and 14 to create the pivot point 16. As the screw 160 is tightened to the two ends 12 and 14, the washer 162 flexes thereby providing added friction to the pivot point so that the two ends do not freely pivot with respect to each other.

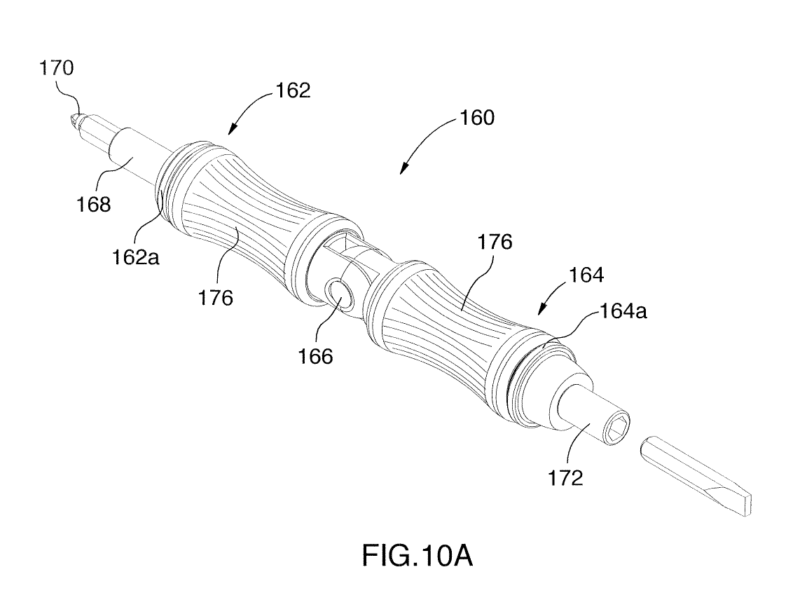

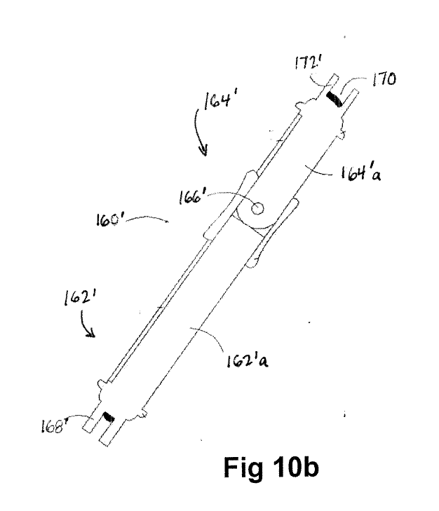

Turning to FIG. 10a, yet a further embodiment of a driving tool is shown. The tool 160 includes a first end 162 comprising a first end shank portion 162a and a second end 164 comprising a second end shank portion 164a. A pivot point 166 is located between the first end 162 and the second 164 to allow the two shank portions 162a and 164a to be pivoted with respect to each other. In the current embodiment, the friction pivot point of FIG. 9 is preferred. The first end 162 includes a bit housing apparatus 168 for housing a precision tool bit 170 and the second end 164 includes a tool bit or accessory housing apparatus 172. The housing apparatus 172 includes a magnet or clip (not shown), located within the apparatus 172 to receive a tool bit 174, or tool accessory and to prevent the tool bit 174 from falling out during use. The tool 160 also includes individual gripping members 176 on each of the first 162 and second 164 ends to provide an improved handle for the tool 160.

A schematic cross-sectional of an embodiment similar to the embodiment of FIG. 10a is shown in FIG. 10b. The tool 160′ includes a first end 162′ and a second 164′ having a shank portion 162a′ and 164a′, respectively. A pivot point 166′ is located between the first end 162′ and the second end 164′. The first end 162′ includes a bit housing apparatus 168′ for housing a precision tool bit and the second end 164′ includes a tool bit or accessory housing apparatus 172′. A magnet 176 is located within each of the housing apparatuses to assist in locking the received bit or accessory in place.

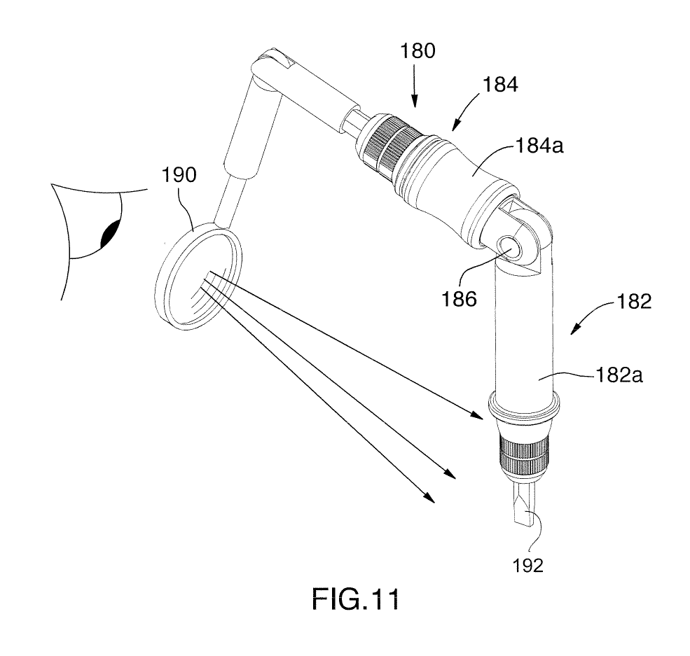

Turning to FIG. 11, another embodiment of a driving tool is shown. In the current embodiment, the tool 180 includes a first end 182 comprising a first end shank portion 182a and a second end 184 comprising a second end shank portion 184a. A pivot point 186 is located between the first end 182 and the second 184 to allow the two shank portions 182a and 184a to be pivoted with respect to each other. As can be seen in this embodiment, the attachments at both ends of the tool 180 can be cooperatively used during a driving application. As shown, a magnifying glass 190 is inserted in the second end 184 while a standard bit 192 is inserted in the first end 182. During use, the user can pivot the tool so that the magnifying glass 190 can be used to expand a view of the working area to assist in the driving application. Alternatively, as with some of the other embodiment described, the bits, and/or tools in the first and second ends operate independent of each other.

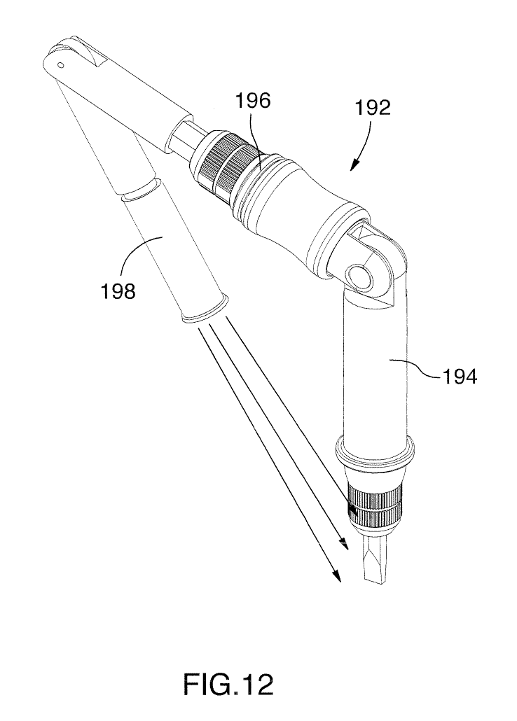

Turning to FIG. 12, yet another embodiment of a driving tool is shown. The driving tool 192 includes a first end 194 and a second end 196. In the current embodiment, a light 198 is inserted into a housing apparatus within the second end 196 to provide an illumination source for the tool 192. As shown the light 198 can itself include pivoting means so that the light can be directed towards the first end to illuminate a working area.

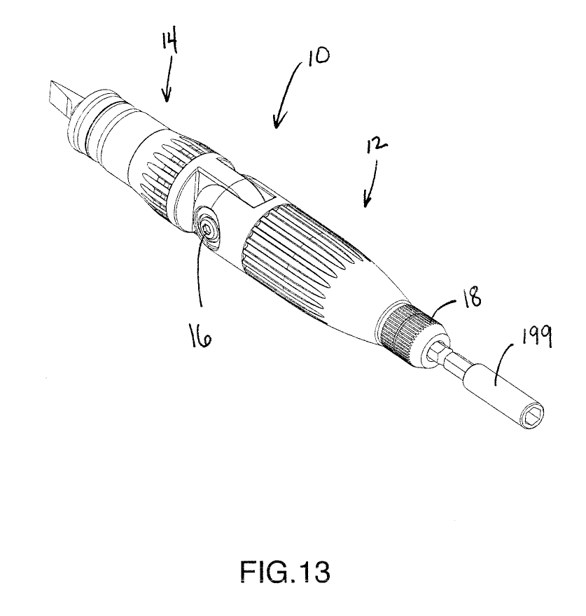

Turning to FIG. 13, yet another embodiment of a driving tool is shown. In the current embodiment, which is identical to FIG. 1a, the fastener driving housing apparatus 18 is used to house a nut setter 199 which can then be used for a driving application.

It may be further understood that although the figures illustrate driving means on each end, the driving tool may also include only one such driving means and driving assisting devices on the opposing ends to that of the driving means. Driving assisting devices may include items such as deburring tools, scratch awls, center-punches, drill bits, taps, nut-setters, files, lasers, LED lights all of which have some form of assistance to the driving application whether in marking, preparing holes for driving a fastener or enabling a better environment for the same. It will be apparent to those skilled in the art that the multipurpose driving tool 10 can take on various mechanical arrangements not necessarily shown in the diagrams herein.

In an alternative embodiment, the tool can include a rubber material on its surface to provide an improved grip for the tool.

While the embodiments described herein are directed to particular implementations of the driving tool, it will be understood that modifications and variations to these embodiments are within the scope and sphere of the present application. Many other modifications and variations may occur to those skilled in the art. All such modifications and variations are believed to be within the sphere and scope of the present application.

What is claimed is:

1. A multi-purpose driving tool comprising:
a first end having a fastener driving housing apparatus for receiving a fastener driving apparatus;
a second end having a tool housing apparatus for receiving a functioning driving apparatus or functioning accessory; and
a pivot point, located between the first and second ends;
wherein the first end and the second end can be pivoted with respect to each other.

2. The driving tool of claim 1 wherein a proportionality of a length of the first end and a length of the second end is based on functionality of the first and the second ends.

3. The driving tool of claim 1 further comprising a locking apparatus for restricting pivoting between the first end and the second end.

4. The driving tool of claim 3 wherein the locking apparatus is a push-button lock.

5. The driving tool of claim 1 wherein the fastener driving apparatus is selected from a group consisting of a standard bit, a precision bit, a precision extension, a precision flex shaft and a nut setter.

6. The driving tool of claim 1 wherein the tool accessory is selected from a group consisting of a magnifying glass, a light, a pencil, a pen, a saw blade, a knife blade, a telescoping magnetic and an adjustable wrench.

7. The driving tool of claim 1 further comprising:
a hand grip collar, slidable along said first and second end;
wherein the hand grip collar is used to lock the pivot point in place when the tool is in a straight position and is used to provide a gripping portion when the tool is in an angular position.

8. The driving tool of claim 1 further comprising:
individual rubber grips on the first end and the second end.

9. The driving tool of claim 1 wherein the first end and the second end are cylindrical, thereby providing a cylindrical driving tool.

10. The driving tool of claim 1 herein the first end and the second end are pivotable between 180 degrees and 90 degrees with respect to each other.

11. The driving tool of claim 10 wherein the first end and second end are pivotable between any angle between 180 degrees and 90 degrees with respect to each other.

12. The driving tool of claim 1 wherein the fastener driving housing apparatus is one of a quick connect system or a chuck/collet system.

13. The driving tool of claim 1 wherein the tool housing apparatus is one of a quick connect system or a chuck/collet system.

14. The driving tool of claim 12 wherein the fastener driving housing apparatus includes a magnet.

15. The driving tool of claim 13 wherein the tool housing apparatus includes a magnet.

16. The driving tool of claim 1 wherein the pivot point is manufactured from steel.

17. The driving tool of claim 1 further comprising a cap for covering either the first end or the second end when the other end is in use, the cap providing a handle for the tool or a lock to the pivot point.

18. The driving tool of claim 1 wherein either the first end or the second end includes a slot for receiving a storage compartment.

19. A multi-purpose driving tool comprising:
a first end having a fastener driving housing apparatus for receiving a fastener driving apparatus;
a second end having an integrated functioning driving apparatus or functioning accessory; and
a pivot point, located between the first and second ends;
wherein the first end and the second end can be pivoted with respect to each other.

20. The multi-purpose tool of claim 19 wherein the standard bit or precision bit in the bit housing apparatus and the integrated functioning tool bit or tool accessory are used in combination for a driving application.
